(19) United States
(12) Patent Application Publication
(10) Pub. No.: US 2021/0200399 A1
(43) Pub. Date: Jul. 1, 2021

(54) DISPLAY APPARATUS AND DISPLAY CONTROL PROGRAM

(71) Applicant: KYOCERA Document Solutions Inc., Osaka (JP)

(72) Inventor: Takanori MIYAMOTO, Osaka (JP)

(73) Assignee: KYOCERA Document Solutions Inc., Osaka (JP)

(21) Appl. No.: 17/058,643

(22) PCT Filed: Apr. 4, 2019
(86) PCT No.: PCT/JP2019/015005

§ 371 Date: Nov. 24, 2020

(30) Foreign Application Priority Data
May 31, 2018 (JP) 2018-104793

(51) Int. Cl. G06F 3/0485; G06F 3/0488; G09G 5/34

(52) U.S. Cl. CPC G06F 3/0485; G09G 5/34; G06F 3/0488

(57) ABSTRACT

A display apparatus (10) includes a display (12), a touch panel (13) disposed on a screen of the display (12), and a controller (21) that causes the screen of the display (12) to display content and, when a scroll operation in a preset defined direction is performed on the touch panel (13), scroll-displays the content on the screen of the display (12) in the defined direction. When a direction of a scroll operation performed on the touch panel (13) deviates from the defined direction, the controller (21) limits the content to a minute distance (R) on the screen of the display (12) and scroll-displays the content in the defined direction.

### TECHNICAL FIELD

The present invention relates to display apparatuses and display control programs, and particularly relates to a technique for scroll-displaying content on a screen of a display.

### BACKGROUND ART

Mobile terminal devices (one example of a display apparatus), such as smart phones, are equipped with a touch panel on a screen of a display, and are configured to accept, through the touch panel, a user operation performed on the screen of the display and to operate in response to this user operation. The user operation includes a touch operation, a scroll operation (so-called flick operation and swipe operation), a drag operation, and so on. For example, when a scroll operation is performed on the touch panel in a state where content is being displayed on the screen of the display, the content is scroll-displayed on the screen of the display.

Patent Literature 1 describes the technique of continuously performing scroll display when a scroll operation to a direction desired to scroll is performed for more than one time. This technique, when a new scroll operation is detected while scrolling is performed continuously, changes, based on a direction of the scroll display on the screen of the display and on a direction of the new scroll operation, a scroll speed on the screen of the display.

### CITATION LIST

### Patent Literature

Patent Literature 1: JP-A-2013-003718

### SUMMARY OF INVENTION

Here, the direction of the scroll display of the screen of the display includes a longitudinal direction and transverse direction. When the screen of the display is small, like a case of a mobile terminal device, if the direction of the scroll display is always displayed by, for example, an arrow or a scroll bar, a freely usable display area of the screen becomes narrow or the screen display becomes intricate. Because of that, display of the arrow or scroll bar may be omitted.

If the user has no idea of the direction of the scroll operation, a scroll operation in a direction that deviates from that direction is sometimes accidentally performed due to the omission. Since the scroll display is not to be performed in response to the scroll operation in this deviating direction, sometimes the user cannot understand why no scroll display is performed.

The technique disclosed in Patent Literature 1 does not deal with such an incorrect scroll operation, nor can it assist the user in the event of the incorrect scroll operation.

The present invention has been made in view of the above circumstance and, the present invention has an object of suggesting the user the direction of the scroll display when a scroll operation is performed by the user in a direction deviating from the direction of the scroll display.

### MEANS FOR SOLVING THE PROBLEM

A display apparatus according to one aspect of the present invention includes a display, a touch panel disposed on a screen of the display, and a controller that causes the screen of the display to display content and, when a scroll operation in a preset defined direction is performed on the touch panel, scroll-displays the content on the screen of the display in the defined direction, wherein when a direction of a scroll operation performed on the touch panel deviates from the defined direction, the controller limits the content to a predetermined amount on the screen of the display and scroll-displays the content in the defined direction.

A display control program according to another aspect of the present invention causes a computer to function as a controller that causes a screen of a display to display content and, when a scroll operation in a preset defined direction is performed on a touch panel disposed on the screen of the display, scroll-displays the content on the screen of the display in the defined direction, and the display control program further causing the computer to function so that when a direction of a scroll operation performed on the touch panel deviates from the defined direction, the controller limits the content to a predetermined amount on the screen of the display and scroll-displays the content in the defined direction.

### EFFECTS OF THE INVENTION

According to the present invention, when a scroll operation is performed in a direction deviating from the direction of the scroll display, the original direction of the scroll display can be suggested to the user.

### BRIEF DESCRIPTION OF DRAWINGS

FIG. 1 is a diagram showing appearance of a display apparatus according to one embodiment of the present invention.

FIG. 2 is a block diagram showing an internal configuration of the display apparatus of the present embodiment.

FIG. 3 is a flowchart showing processing procedures for scroll-displaying content on a screen of a display.

FIG. 4A is a diagram showing a state of the content scroll-displayed in a left-right transverse direction of the screen of the display.

FIG. 4B is a diagram showing a state of the content scroll-displayed in the left-right transverse direction of the screen of the display.

FIG. 4C is a diagram showing a state of the content scroll-displayed in the left-right transverse direction of the screen of the display.

FIG. 4D is a diagram showing a state of the content scroll-displayed in the left-right transverse direction of the screen of the display.

FIG. 4E is a diagram showing a state of the content scroll-displayed in the left-right transverse direction of the screen of the display.

FIG. 5 is a diagram showing a range of a scroll operation in the left-right transverse direction of the screen of the display.

FIG. 6A is a diagram showing a state of the content scroll-displayed in an up-down longitudinal direction of the screen of the display.

FIG. 6B is a diagram showing a state of the content scroll-displayed in the up-down longitudinal direction of the screen of the display.

FIG. 6C is a diagram showing a state of the content scroll-displayed in the up-down longitudinal direction of the screen of the display.

FIG. 6D is a diagram showing a state of the content scroll-displayed in the up-down longitudinal direction of the screen of the display.

FIG. 6E is a diagram showing a state of the content scroll-displayed in the up-down longitudinal direction of the screen of the display.

FIG. 7 is a diagram showing a range of a scroll operation in the up-down longitudinal direction of the screen of the display.

FIG. 8 is a diagram showing the content scroll-displayed in the left-right transverse direction and the up-down longitudinal direction of the screen of the display.

FIG. 9 is a diagram showing the range of the scroll operation in the left-right transverse direction and the up-down longitudinal direction of the screen of the display.

FIG. 10 is a diagram showing a state where the content is being scroll-displayed on the screen of the display at up to a terminal position in the left transverse direction and to a terminal position in the up longitudinal direction.

### DESCRIPTION OF EMBODIMENTS

Hereinafter, a detailed description will be given of a display apparatus according to one embodiment of the present invention, with reference to the drawings.

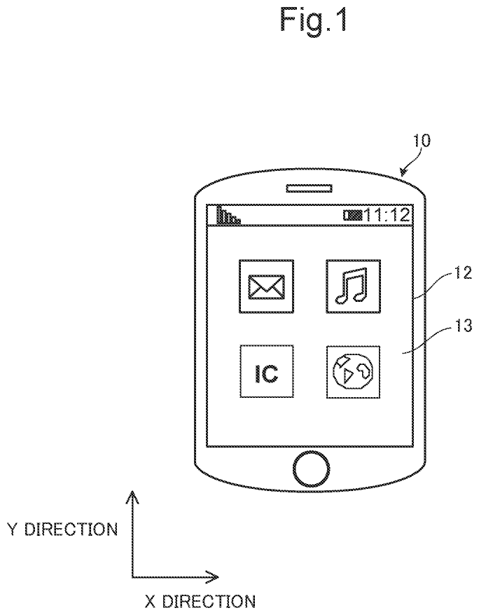

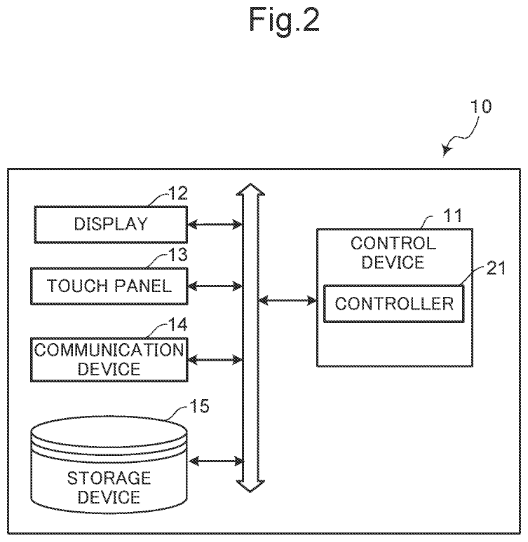

FIG. 1 is a diagram showing appearance of the display apparatus according to one embodiment of the present invention. FIG. 2 is a block diagram showing an internal configuration of the display apparatus of the present embodiment.

A display apparatus 10 of the present embodiment is, for example, a mobile terminal device such as a smart phone, and provided with a display 12, a touch panel 13, a communication device 14, a storage device 15, and a control device 11. These components are capable of sending and receiving data or signals to and from each other via a bus.

The display 12 is formed of a liquid crystal display (LCD), an organic EL (OLED: Organic Light-Emitting Diode) display or the like.

The touch panel 13 is a touch panel of a so-called resistive film system, a capacitance system, or other systems. The touch panel 13 is disposed on a screen of the display 12 and detects contact made by a finger or the like on the screen of the display 12 together with a point of the contact. Upon detecting the contact made by the finger or the like, the touch panel 13 outputs a detection signal indicating the coordinate of the point of the contact to the controller 21 in the control device 11, and so on. Accordingly, the touch panel 13 serves a role as an operating device, into which a user operation performed on the screen of the display 12 is to be inputted.

Also, as the operating device into which a user operation is to be inputted, the display apparatus 10 may be provided with hard keys in addition to the above-described touch panel 13.

The communication device 14 is a communication interface including a communication module such as a not-illustrated LAN chip.

The storage device 15 is formed of a large capacity solid state drive (SSD), hard disk drive (HDD), and the like, and stores various types of data and programs.

The control device 11 is composed of a processor, a random access memory (RAM), a read only memory (ROM), and so on. The processor is, for example, a central processing unit (CPU), an application specific integrated circuit (ASIC), a micro processing unit (MPU), or the like. When a control program stored in the above ROM or storage device 15 is executed by the above processor, the control device 11 functions as the controller 21. The controller 21 may not be implemented by the operation in accordance with the aforesaid control program but may be constituted by a hardware circuit.

The controller 21 governs the overall operation control of the display apparatus 10. The control device 11 is connected to the display 12, the touch panel 13, the communication device 14, the storage device 15, and others. The controller 21 performs operation control of each of these components and sends and receives signals or data among each of the components.

The controller 21 serves a role as a processing unit that executes various kinds of processing. The controller 21 has a function of controlling communication operation of the communication device 14. Furthermore, the controller 21 has a function of controlling display operation of the display 12.

Also, the controller 21, based on a detection signal outputted from the touch panel 13, determines a user operation inputted by the user. Then, the controller 21 accepts the determined user operation and operates in response to this user operation.

The aforesaid user operation includes a touch operation, scroll operation (so-called flick operation, swipe operation), and drag operation. For example, when the user touches the touch panel 13 with his or her finger and immediately releases it, the touch panel 13 outputs the detection signal indicating the position where the touch was detected to the controller 21. Upon inputting the detection signal, the controller 21 determines, based on the detection signal, that this user operation is a touch operation, and accepts this touch operation. The touch operation is, for example, performed on a soft key that the controller 21 causes the screen of the display 12 to display.

Also, when the user moves his or her finger while touching the touch panel 13, the touch panel 13 outputs a detection signal indicating each moving position from the initial position where the touch was first detected to the final position where the touch was last detected to the controller 21. Upon inputting the detection signal, the controller 21 determines, based on the detection signal, that this user operation is a swipe operation, and determines the operation direction of the swipe operation, and accepts this swipe operation. In accordance with this swipe operation, the controller 21 scroll-displays the content, such as a text and an image being displayed on the screen of the display 12.

In addition, when the user touches the touch panel 13 with his or her finger and simultaneously moves it quickly and releases it from the touch panel 13, in other words, when the user performs a flicking-like operation on the touch panel 13 with his or her finger, the touch panel 13 outputs a detection signal indicating each moving position from the initial position where the touch was first detected to the final position where the touch was last detected to the controller 21. Upon inputting the detection signal, the controller 21 detects, based on the detection signal, the quick change in the touched positions occurred in a short time, determines that the user operation is a flick operation and the operation direction of the flick operation, and accepts this flick operation. In accordance with this flick operation, the controller 21 scroll-displays the content, such as a text and an image being displayed on the screen of the display 12. For example, when performing the scroll display, the controller 21 performs display control so as that the moving speed of the content on the screen of the display 12 is the fastest at the start time of the scroll display, gradually slows down with the lapse of time from the start time, and finally becomes “0”.

Here, as for the direction of the scroll display of the screen of the display 12 (that is, a preset defined direction), there are, for example, a longitudinal direction (a predetermined one direction; such as y direction shown in FIG. 1) and a transverse direction (the direction orthogonal to the aforesaid one direction; such as x direction shown in FIG. 1). Since the screen of the display 12 of the display apparatus 10 which is a mobile terminal device is small, if the direction of the scroll display is always displayed by, for example, an arrow or a scroll bar, a freely usable display area of the screen becomes narrow or the screen display becomes intricate.

For this reason, the user fails to see the direction of the scroll display and there are some cases where the user performs a scroll operation by mistake in a direction different from the scroll display direction (the direction deviating from the scroll display direction). Since scroll display is not to be performed in response to the scroll operation in this deviating direction, sometimes the user cannot understand why no scroll display is performed.

In view of the foregoing, in the present embodiment, the controller 21 determines whether the direction of the scroll operation (the aforesaid flick operation or swipe operation) performed on the touch panel 13 deviates from the direction of the scroll display. When the direction of the scroll operation deviates from the direction of the scroll display, the controller 21 scroll-displays the content being displayed on the screen of the display 12, by only the predetermined amount in the direction of the scroll display. Thereby, even if the user performs the scroll operation in the deviating direction, by seeing the scroll display performed by the predetermined amount and its direction, the user can perceive the correct direction of the scroll operation (the same direction as the direction of the scroll display).

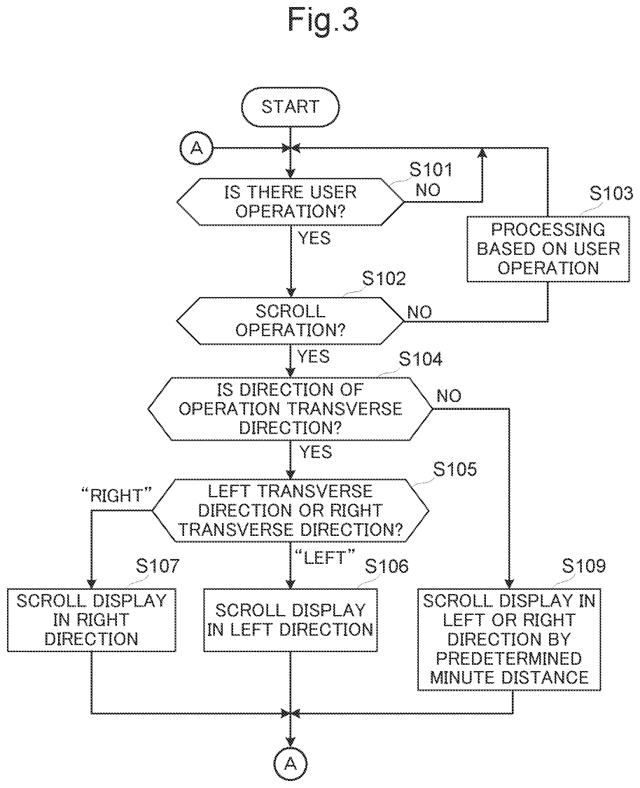

Next, in the display apparatus 10 of the present embodiment, processing procedures for scroll-displaying content on the screen of the display 12 will be described with reference to a flowchart shown in FIG. 3 and so on.

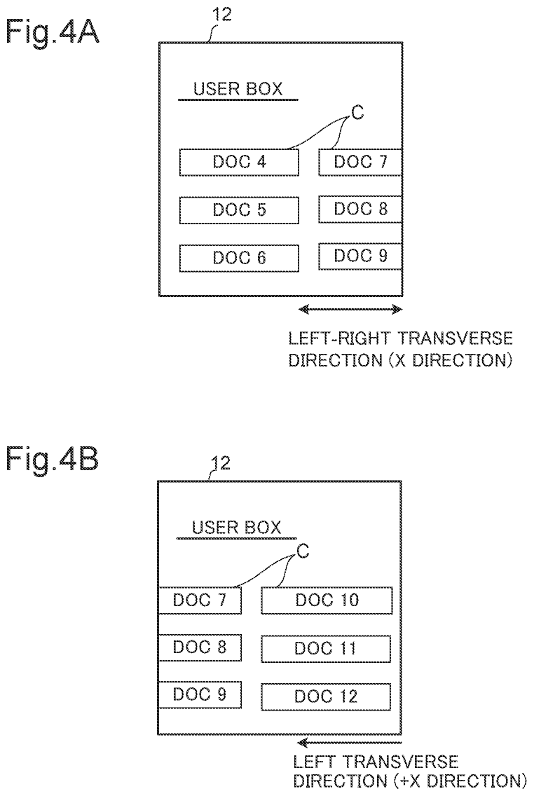

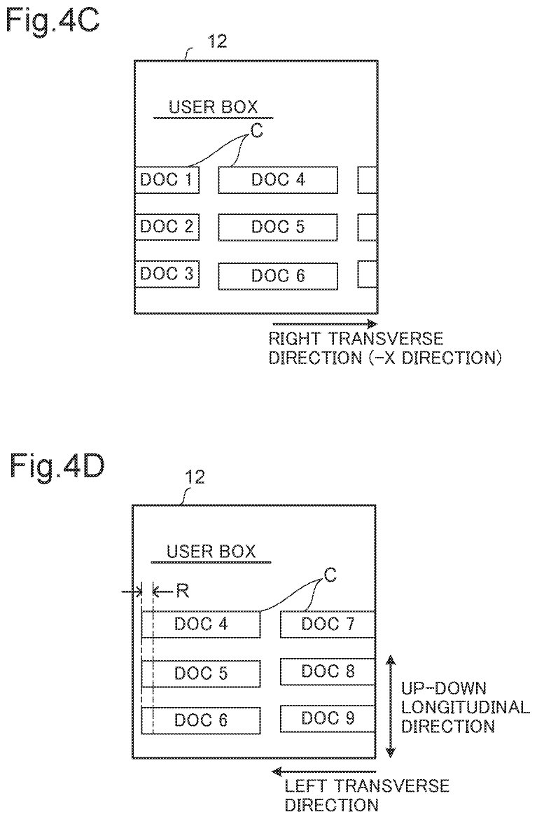

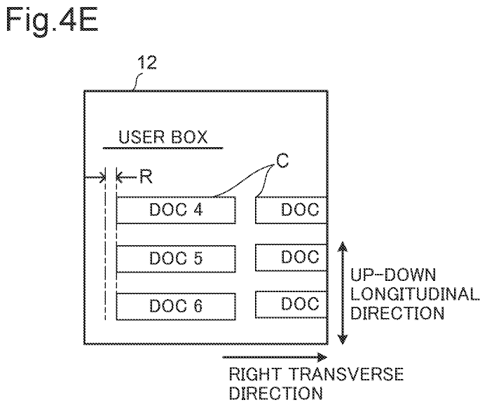

It is assumed, for example, while the controller 21 is scroll-displaying content C on the screen of the display 12 as shown in FIG. 4A, the direction of the scroll display of the content C on the screen is only the left-right transverse direction (predetermined direction; such as x direction shown in FIG. 4A).

The controller 21 is waiting for a user operation to be performed on the touch panel 13 (“NO” at S101), and upon deciding, based on the detection signal from the touch panel 13, that the user operation on the touch panel 13 is performed (“YES” at S101), further determines whether the user operation is a scroll operation (flick operation) or not (S102). Upon determining that the user operation is not the scroll operation (“NO” at S102), the controller 21 executes response processing associated with the user operation, which is different from the scroll operation (S103). For example, when the user operation is a touch operation performed on an icon (one example of the content), the controller 21 determines the touch operation on the icon and executes the processing associated with the icon. Thereafter processing returns to S101.

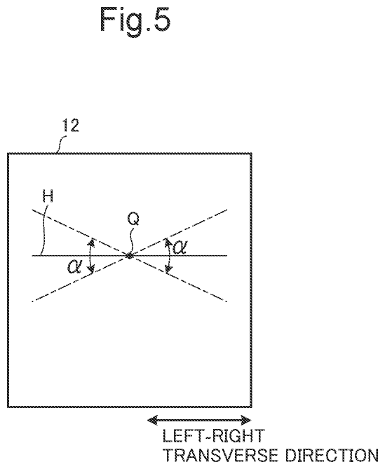

Furthermore, upon determining that the user operation is the scroll operation (“YES” at S102), the controller 21 determines whether the direction of this scroll operation is the left-right transverse direction (S104). For example, as shown in FIG. 5, if a start position Q of the scroll operation is the center of a fan-shape and a line in the transverse direction passing through the start position Q is a center line H, when deciding that the direction of the scroll operation is within a fan-shaped angular range α extending on both sides of the center line H, the controller 21 determines that the direction of the scroll operation is the left-right transverse direction. Also, when the direction of the scroll operation is not within the predetermined fan-shaped angular range α, the controller 21 determines that the direction of the scroll operation is not the left-right transverse direction, in other words, the direction of the scroll operation is deviating from the direction of the scroll display.

Upon determining that the direction of the scroll operation is the left-right transverse direction (“YES” at S104), the controller 21 determines if the direction of the scroll operation is either the left transverse direction (for example, +x direction shown in FIG. 4B) or the right transverse direction (for example, −x direction shown in FIG. 4C) (S105). For example, upon determining that the direction of the scroll operation is the left transverse direction (“LEFT” at S105), the controller 21, based on image data of the content C stored in the storage device 15 in advance, scroll-displays the content C on the screen of the display 12 as shown in FIG. 4B in the instructed left transverse direction by the scroll amount indicated by the scroll operation (S106).

Furthermore, upon determining that the direction of the scroll operation is the right transverse direction (“RIGHT” at S105), the controller 21, based on the image data of the content C stored in the storage device 15 in advance, scroll-displays the content C on the screen of the display 12 as shown in FIG. 4C in the instructed right transverse direction by the scroll amount indicated by the scroll operation (S107). After S106 and S107, processing returns to S101.

Furthermore, when determining that the direction of the scroll operation is not within the predetermined fan-shaped angular range α and therefore the direction of the scroll operation is not the left-right transverse direction (“NO” at S104), the controller 21 executes the scroll display that is performed in the left transverse direction or the right transverse direction and by a predetermined minute distance R (S109).

For example, the minute distance R is defined as a predetermined constant amount less than the scroll amount indicated by the scroll operation. For example, if the scroll amount indicated by the scroll operation is less than the minute distance R, the controller 21 may not perform the scroll display of the minute distance R. Hereinafter, the same applies to all the cases of the minute distance R.

For example, based on the image data of the content C stored in the storage device 15 in advance, as shown in FIG. 4D or FIG. 4E, the controller 21 scroll-displays the content C on the screen of the display 12 in the left transverse direction or the right transverse direction and by the predetermined minute distance R (S109). That is, when determining that the direction of the scroll operation is not the left-right transverse direction (“NO” at S104), the controller 21 limits the content C on the screen of the display 12 to the minute distance R and scroll-displays the content C in either of the left transverse direction or the right transverse direction having been determined in advance (S109). Thereafter processing returns to S101.

In doing so, even though the user has performed the scroll operation in the direction deviating from left-right transverse direction (a direction different from the left-right transverse direction, such as an up-down direction), the content C is scroll-displayed on the screen of the display 12 in the left transverse direction or the right transverse direction by only the minute distance R. Therefore, by seeing the scroll display, the user becomes capable of perceiving that the direction of the scroll operation that he or she has performed is wrong and that the direction to be scroll-displayed and the correct direction of the scroll operation is the left-right transverse direction.

Thereafter, by the controller 21, when it is determined that the user has performed the scroll operation in the left-right transverse direction (“YES” at S101), it is determined that the direction of the scroll operation is the left-right transverse direction (“YES” at S102, “YES” at S104), and furthermore, when it is determined that the direction of the scroll operation is the left transverse direction (“LEFT” at S105), the scroll display in the left direction is performed (S106). Also, when it is determined by the controller 21 that the direction of the scroll operation is the right transverse direction (“RIGHT” at S105), the scroll display in the left direction is performed (S107).

As described above, in the present embodiment, when the direction of the scroll operation performed on the touch panel 13 deviated from the direction of the scroll display, the content C being displayed on the screen of the display 12 is scroll-displayed in the original direction of the scroll display by only the minute distance R. Thereby, by seeing the direction of the scroll display of the content C, the user becomes capable of perceiving the original direction of the scroll display and the correct direction of the scroll operation. In other words, according to the present embodiment, when the scroll operation is performed in the direction deviating from the direction of the scroll display, the original direction of the scroll display can be suggested to the user. Furthermore, since the scroll display in the original direction in this case is the scroll display of the minute distance R, the content displayed on the screen does not change significantly.

### Modification 1

In Modification 1, when a scroll operation deviating from the direction of the scroll display is repeatedly performed in more than once, the controller 21 scroll-displays the content being displayed on the screen of the display 12 by only the predetermined amount in the direction of the scroll display.

The controller 21 sequentially determines the scroll operation performed on the touch panel 13, and every time in determining that the direction of the scroll operation is not the left-right transverse direction (the correct scroll operation direction), counts a continuous number of times of the scroll operation performed in the direction that is not the left-right transverse direction (erroneous scroll operation direction). If the continuous number of times of the scroll operation performed in the wrong direction is only one, the controller 21 does not perform the aforesaid control of scroll-displaying the content C on the screen of the display 12 in the left transverse direction or the right transverse direction by only the minute distance R; when it reaches a preset constant number of times (for example three times), the controller 21 performs the control of scroll-displaying by only the minute distance R.

### Modification 2

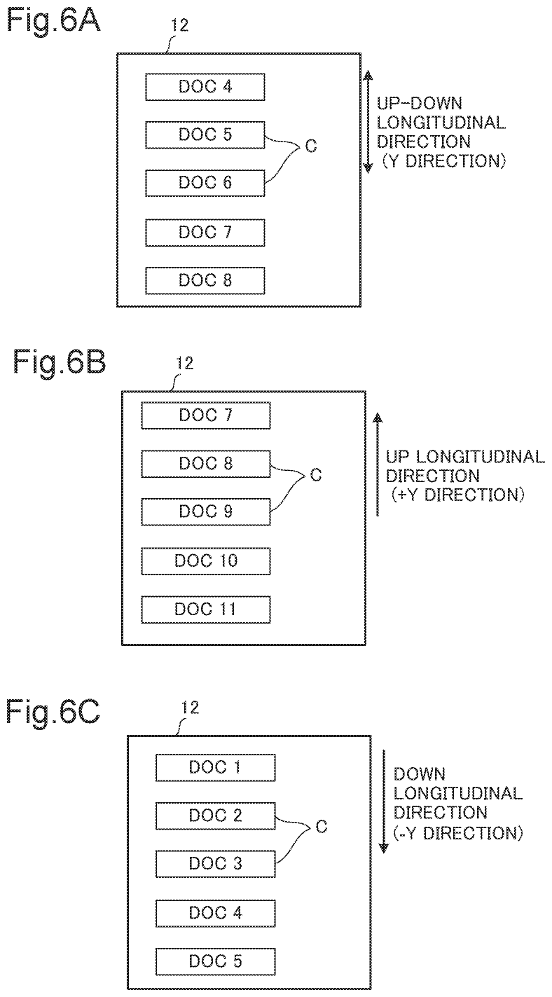

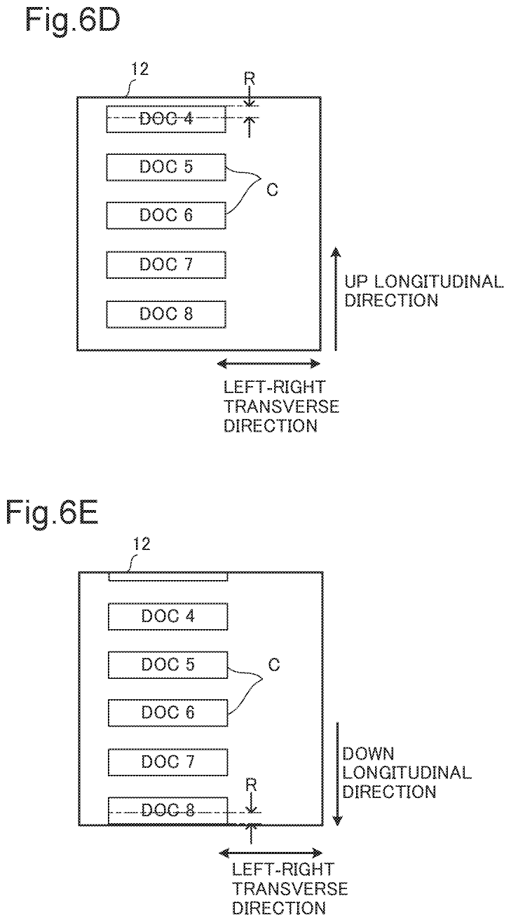

In Modification 2, as shown in FIG. 6A, the direction of the scroll display of the content C performed on the screen of the display 12 is only the up-down longitudinal direction (y direction).

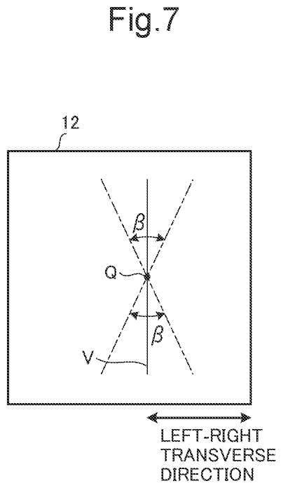

It is assumed that the user has performed on the touch panel 13 a scroll operation in the up longitudinal direction (for example, +y direction shown in FIG. 6B) or in the down longitudinal direction (for example, −y direction shown in FIG. 6C). At this point, as shown in FIG. 7, if the controller 21 decides that the direction of the scroll operation is within a predetermined fan-shaped angular range β (having the start position Q of the scroll operation as the center of the fan-shape and extending in both sides of a center line V in the longitudinal direction passing through the start position Q), the controller 21 determines that the direction of the scroll operation is the up longitudinal direction or the down longitudinal direction, and performs the scroll display in the determined up longitudinal direction or the down longitudinal direction. For example, the controller 21 scroll-displays the content C on the screen of the display 12 in the determined direction, as shown in FIG. 6B or FIG. 6C.

Furthermore, it is assumed, for example, that the user has performed the scroll operation on the touch panel 13 in the direction deviating from the up longitudinal direction or the down longitudinal direction. At this time, the controller 21 decides that the direction of the scroll operation is out of the predetermined fan-shaped angular range β and that the direction of the scroll operation is not the up-down longitudinal direction. In this case, the controller 21 performs the scroll display in the predetermined direction that is either the up longitudinal direction or the down longitudinal direction by only the predetermined minute distance R. For example, the controller 21, as shown in FIG. 6D and FIG. 6E, scroll-displays the content C on the screen of the display 12 in the up longitudinal direction or the down longitudinal direction by only the minute distance R. Therefore, by seeing the scroll display of the minute distance R, the user becomes capable of perceiving that the direction of the scroll operation he or she has performed is wrong and that the up-down longitudinal direction (y direction) is the correct scroll display direction and scroll operation direction.

### Modification 3

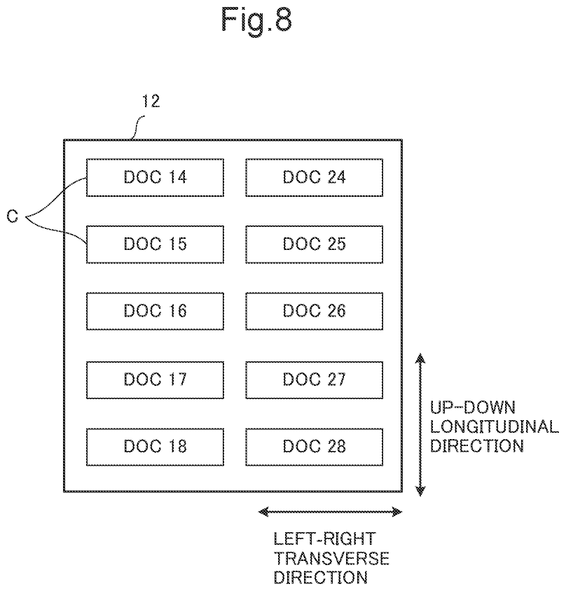

Modification 3 is, as shown in FIG. 8, based on the premise that the direction of the scroll display of the content C on the screen of the display 12 is the left-right transverse direction and the up-down longitudinal direction. Here, one direction of the left-right transverse direction and the up-down longitudinal direction corresponds to the first defined direction, and the other direction thereof corresponds to the second defined direction.

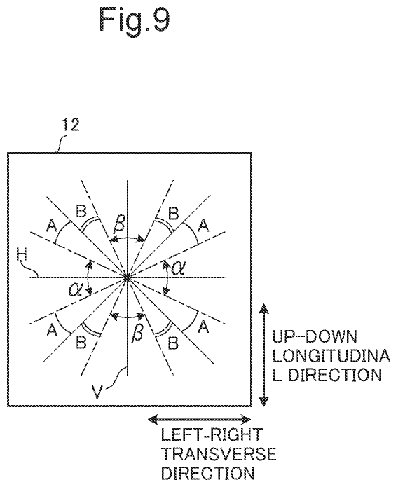

It is assumed that the user performs the scroll operation in the left-right transverse direction or the up-down longitudinal direction on the touch panel 13. As shown in FIG. 9, when deciding that the direction of the scroll operation is within the predetermined fan-shaped angular range α, the controller 21 determines that the direction of the scroll operation is the left-right transverse direction, and scroll-displays the content C on the screen of the display 12 in the direction of the scroll operation (the left transverse direction or the right transverse direction). Also, as shown in FIG. 9, when deciding that the direction of the scroll operation is within the predetermined fan-shaped angular range β, the controller 21 determines that the direction of the scroll operation is the up-down longitudinal direction, and causes, by the controller 21, the content C on the screen of the display 12 to be scroll-displayed in the direction of the scroll operation (the up longitudinal direction or the down longitudinal direction).

Furthermore, when deciding that the direction of the scroll operation falls within neither of the fan-shaped angular ranges α and β, the controller 21 determines if the direction of the scroll operation falls within either the range A adjacent to the fan-shaped angular range α, or a range B adjacent to the fan-shaped angular range β. When the controller 21 determines that the direction of the scroll operation falls within the range A adjacent to the fan-shaped angular range α, the content C on the screen of the display 12 is caused to be scroll-displayed in the left transverse direction or the right transverse direction and by the predetermined minute distance R by the controller 21. Also, when the controller 21 determines that the direction of the scroll operation falls within the range B adjacent to the fan-shaped angular range β, the content C on the screen of the display 12 is caused to be scroll-displayed in the up longitudinal direction or the down longitudinal direction and by the predetermined minute distance R by the controller 21. Thereby, even if the user performs the scroll display by mistake in any directions of the left-right transverse direction or the up-down longitudinal direction, this allows the user to perceive the original scroll display direction and the correct scroll operation.

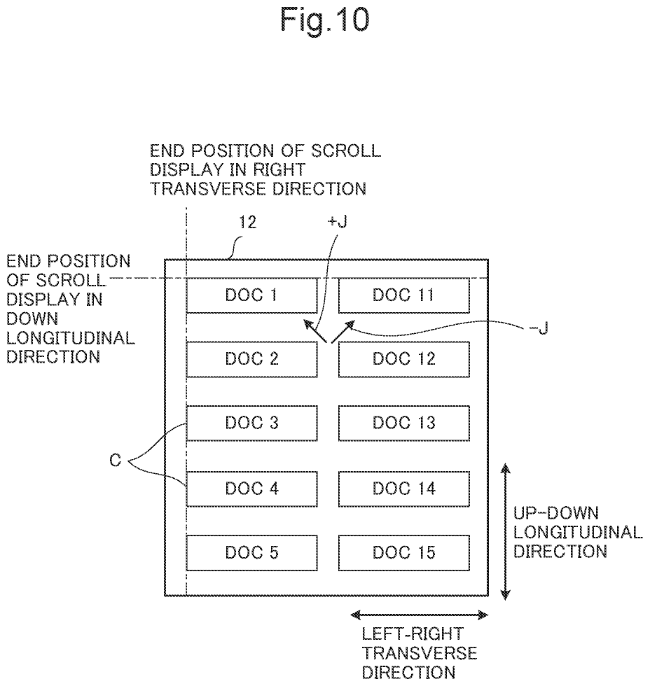

Furthermore, as shown in FIG. 10, it is assumed that, in a state where the content C is reaching the end position of the scroll display in the right transverse direction and the end position of the scroll display in the down longitudinal direction on the screen of the display 12, the controller 21 determines that the user has further performed a scroll operation in the right transverse direction or the down longitudinal direction on the touch panel 13. In this case, the controller 21 determines that the content C cannot be scroll-displayed by going over these end positions, and the content C on the screen of the display 12 is caused to be scroll-displayed by the controller 21 in +J direction that is a predetermined direction different from the right transverse direction or the down longitudinal direction in which the scroll operation has been performed (for example, diagonally upward to the left: directions that include constituents in both directions that can be scroll-displayed), by only the predetermined minute distance R.

Furthermore, it is assumed that, in a state where the content C is reaching the end position of the scroll display in the left transverse direction and the end position of the scroll display in the down longitudinal direction on the screen of the display 12, the controller 21 determines that the user has further performed a scroll operation in the left transverse direction or the down longitudinal direction on the touch panel 13. In this case, the controller 21 determines that the content C cannot be scroll-displayed by going over these end positions, and the content C on the screen of the display 12 is caused to be scroll-displayed in −J direction that is a predetermined direction different from the left transverse direction or the down longitudinal direction in which the scroll operation has been performed (for example, diagonally upward to the right: directions that include constituents in both directions that can be scroll-displayed), by only the predetermined minute distance R.

Similarly, it is assumed that, in a state where the content C is reaching the end position of the scroll display in the right transverse direction and the end position of the scroll display in the up longitudinal direction on the screen of the display 12, or in a state where the content C is reaching the end position of the scroll display in the left transverse direction and the end position of the scroll display in the up longitudinal direction, the controller 21 determines that a scroll operation in the direction beyond these end positions is performed. In this case, the controller 21 scroll-displays the content C in the opposite direction (diagonally downward to the left or diagonally downward to the right) from the direction beyond those end positions, by only the minute distance R.

Furthermore, in a state where the content C is reaching the end position of the scroll display in the right direction or the end position of the scroll display in the left transverse direction on the screen of the display 12, when a scroll operation in the direction beyond these end positions is performed, the content C may be scroll-displayed in the left transverse direction or the right transverse direction by only the minute distance R.

Similarly, in a state where the content C is reaching the end position of the scroll display in the down longitudinal direction or the end position of the scroll display in the up longitudinal direction on the screen of the display 12, when a scroll operation in the direction beyond these end positions, the content C may be scroll-displayed in the up longitudinal direction or the down longitudinal direction by only the minute distance R.

By the aforesaid the scroll display of the minute distance R, the user can perceive that it is reaching the end position of the scroll display.

Although in the above embodiment and modifications the controller 21 scroll-displays the content C by only the minute distance R on the screen of the display 12, (that is, maintains the display state after scroll display), it may be configured that after scroll-displaying the content C by only the minute distance R, the content C is scroll-displayed in the backward direction until it is displayed at the previous position where displayed before the scroll display was performed

The display method by the display apparatus 10 described in the above embodiments can be provided as a control program stored in the ROM or the storage device 15. This control program is recorded on a computer-readable non-transitory recording medium, such as a hard disk, a CD-ROM, a DVD-ROM or a semiconductor memory. In this case, the computer-readable non-transitory recording medium with the control program recorded thereon is one embodiment of the present invention.

The configurations and processing of the above embodiments described with reference to FIG. 1 to FIG. 10 are merely one embodiment exemplifies the present invention, and not intended to limit the present invention to the above particular configurations and processing.

What is claimed is:

1. A display apparatus comprising:
a display;
a touch panel disposed on a screen of the display; and
a controller that causes the screen of the display to display content and, when a scroll operation in a preset defined direction is performed on the touch panel, scroll-displays the content on the screen of the display in the defined direction,
wherein when a direction of a scroll operation performed on the touch panel deviates from the defined direction, the controller limits the content to a predetermined amount on the screen of the display and scroll-displays the content in the defined direction.

2. The display apparatus according to claim 1, wherein
the controller, when a scroll operation in a direction deviating from the defined direction is repeatedly performed on the touch panel, counts a continuous number of times of the scroll operation and, when the continuous number of times reaches a preset constant number of times, performs control of scroll-displaying the content on the screen of the display by only the predetermined amount in the defined direction.

3. The display apparatus according to claim 1, wherein
when the controller performed control of scroll-displaying the content on the screen of the display by only the predetermined amount in the defined direction, the controller subsequently scroll-displays the content by only the predetermined amount in a opposite direction from the defined direction and performs control of returning a display state on the screen of the display to a state before scroll-displaying by only the predetermined amount in the defined direction.

4. The display apparatus according to claim 1, wherein
the predetermined amount is defined as a predetermined constant amount less than a scroll amount indicated by the scroll operation performed by the user, and the controller, when the scroll amount indicated by the scroll operation is less than the predetermined amount, does not perform the scroll display by the predetermined amount.

5. The display apparatus according to claim 1, wherein
in a state where an end of the scroll display in the defined direction is reached, when the scroll operation in the defined direction is performed, the controller scroll-displays the content in an opposite direction from the defined direction by only the predetermined amount.

6. The display apparatus according to claim 1, wherein
the controller determines whether the direction of the scroll operation performed on the touch panel deviates from the defined direction.

7. The display apparatus according to claim 6, wherein
if a start position of the scroll operation performed on the touch panel is a center of a fan-shape and a line in the defined direction passing through the start position is a center line, when deciding that the direction of the scroll operation performed on the touch panel is within a predetermined fan-shaped angular range extending on both sides of the center line, the controller determines that the direction of the scroll operation performed on the touch panel is the defined direction, and when deciding that the direction of the scroll operation performed on the touch panel is not within the predetermined fan-shaped angular range, the controller determines that the direction of the scroll operation performed on the touch panel is deviating from the defined direction.

8. The display apparatus according to claim 1, wherein the controller,
when a scroll operation in either a first defined direction or a second defined
direction that are set beforehand and orthogonal to each other is performed on the touch panel, scroll-displays the content on the screen of the display by the scroll amount indicated by the scroll operation in the first defined direction or the second defined direction to which the scroll operation was performed,
when the direction of the scroll operation performed on the touch panel deviates from the first defined direction or the second defined direction, limits the content to the predetermined amount and scroll-displays the content on the screen of the display in either the first defined direction or the second defined direction, and
in a state where an end of the scroll display in the first defined direction or the second defined direction is reached, when the scroll operation in the first defined direction or the second defined direction is performed, scroll-displays the content in a predetermined direction different from the first defined direction or the second defined direction, by only the predetermined amount.

9. A display control program causing a computer to function as a controller that causes a screen of a display to display content and, when a scroll operation in a preset defined direction is performed on a touch panel disposed on the screen of the display, scroll-displays the content on the screen of the display in the defined direction,
the display control program further causing the computer to function so that when a direction of a scroll operation performed on the touch panel deviates from the defined direction, the controller limits the content to a predetermined amount on the screen of the display and scroll-displays the content in the defined direction.
